(19) United States
(12) Patent Application Publication
(10) Pub. No.: US 2025/0068365 A1
(43) Pub. Date: Feb. 27, 2025

(54) IMAGE PROCESSING METHOD AND APPARATUS, ELECTRONIC APPARATUS, AND STORAGE MEDIUM

(71) Applicant: Beijing Pantum Information Technology Ltd., Beijing (CN)

(72) Inventor: Yu HUANG, Beijing (CN)

(21) Appl. No.: 18/805,527

(22) Filed: Aug. 14, 2024

(30) Foreign Application Priority Data
Aug. 24, 2023 (CN) 202311075748.3

(51) Int. Cl. G06F 3/12; G06K 15/02

(52) U.S. Cl. CPC G06F 3/1215; G06F 3/1206; G06F 3/1247; G06K 15/1852

(57) ABSTRACT

An image processing method is applied to a driver-end device, including obtaining an image-to-be-printed and extracting a text part and an image part from the image-to-be-printed. The image processing method includes converting all extracted image parts on one page into first image data. The image processing method includes converting the extracted text part into a page description language. The image processing method includes generating an image instruction based on the first image data and inserting the image instruction into the page description language to form a target page description language. The image processing method also includes sending the target page description language to an image forming device to execute an image forming job.

### CROSS-REFERENCE TO RELATED APPLICATION

This application claims priority to Chinese Patent Application No. 202311075748.3, filed on Aug. 24, 2023, the entire content of which is incorporated herein by reference.

### TECHNICAL FIELD

The present disclosure relates to the technical field of image processing and, in particular, to an image processing method and apparatus, an electronic apparatus, and a storage medium.

### BACKGROUND

When a page description language (PDL) printer executes a print job, each page to be printed is data independent of an imaging device (e.g., printer). The page requires a PDL interpreter on the printer to follow a PDL instruction to render the page to be printed.

If a page to be printed contains multiple images, a corresponding number of image PDL instructions will be generated based on the multiple images. When printing, it takes time to analyze each PDL instruction and perform raster operations on the image on the page, thus affecting printing speed.

### SUMMARY

One aspect of the present disclosure provides an image processing method that is applied to a driver-end device. The image processing method includes obtaining an image-to-be-printed and extracting a text part and an image part from the image-to-be-printed. The image processing method includes converting all extracted image parts on one page into first image data. The image processing method includes converting the extracted text part into a page description language. The image processing method includes generating an image instruction based on the first image data and inserting the image instruction into the page description language to form a target page description language. The image processing method also includes sending the target page description language to an image forming device to execute an image forming job.

One aspect of the present disclosure provides an image processing method that is applied to an image forming device. The image processing method includes restoring a page based on a received target page description language to obtain a third page. The image processing method includes performing different halftone conversions on an image and text from the third page. The image processing method further includes integrating the halftone converted image and text into a raster image, and executing printing based on the raster image.

One aspect of the present disclosure provides an image processing apparatus. The image processing apparatus includes a receiving unit, configured to obtain an image-to-be-printed and extract a text part and an image part from the image-to-be-printed. The image processing apparatus includes a processing unit, configured to convert all extracted image parts on one page into first image data, convert the extracted text part into a page description language, and generate an image instruction based on the first image data and inserting the image instruction into the page description language to form a target page description language. The image processing apparatus further includes a sending unit, configured to send the target page description language to an image forming device to execute an image forming job.

Another aspect of the present disclosure provides an image processing apparatus. The image processing apparatus includes a page processing unit, configured to restore a page based on a received target page description language to obtain a third page and perform different halftone conversions on an image and text from the third page. The image processing apparatus further includes a printing unit, configured to integrate the halftone converted image and text into a raster image, and execute printing based on the raster image.

### BRIEF DESCRIPTION OF THE DRAWINGS

In order to better convey embodiments of the present disclosure or the technical solutions, a brief introduction will be described below to the drawings that need to be used in the description of embodiments or technical solutions. Obviously, the drawings in the following description are some embodiments of the present disclosure. For those persons of ordinary skill in the art, other drawings can be obtained based on these drawings without exerting any creative effort.

FIG. 1 illustrates a schematic structural diagram of an image forming device according to one embodiment of the present disclosure.

FIG. 2 illustrates a schematic diagram of generating a multi-image page description language instruction.

FIG. 3 illustrates a schematic diagram of generating a multi-image page description language instruction according to one embodiment of the present disclosure.

FIG. 4 illustrates a schematic flow chart of an image processing method according to one embodiment of the present disclosure.

FIG. 5 illustrates a schematic diagram of page integration according to one embodiment of the present disclosure.

FIG. 6 illustrates a schematic diagram of an overlapping image part and a text part according to one embodiment of the present disclosure.

FIG. 7 illustrates a schematic flow chart of an image processing method according to another embodiment of the present disclosure.

FIG. 8 illustrates a schematic flow chart of an image processing method according to another embodiment of the present disclosure.

FIG. 9 illustrates a schematic structural diagram of an image processing apparatus according to one embodiment of the present disclosure.

FIG. 10 illustrates a schematic structural diagram of an image processing apparatus according to another embodiment of the present disclosure.

FIG. 11 illustrates a schematic structural diagram of an electronic apparatus according to one embodiment of the present disclosure.

### DETAILED DESCRIPTION OF THE EMBODIMENTS

To better describe the purpose, technical solutions, and advantages of embodiments of the present disclosure, specific technical solutions of embodiments of the present disclosure will be further described in detail in conjunction with the drawings in embodiments of the present disclosure. The following examples are used to illustrate the present disclosure but are not intended to limit the scope of the present disclosure. Based on embodiments of the present disclosure, all other embodiments obtained by those persons of ordinary skill in the art without creative efforts fall within the scope of protection of the present disclosure.

In the present disclosure, “at least one” refers to one or more. “Plurality” and “multiple” refer to two or more. “And/or” describes the association of associated objects, indicating that there can be three relationships, for example, A and/or B, which can mean: A exists alone, A and B exist simultaneously, and B exists alone, where A, B can be singular or plural. The character “/” generally indicates that the related objects are in an “or” relationship. “At least one of the following” or similar expressions refers to any combination of these items, including any combination of single item or plural items. For example, at least one of a, b, or c can mean: a, b, c, a-b, a-c, b-c, or a-b-c, where a, b, c can be single or multiple.

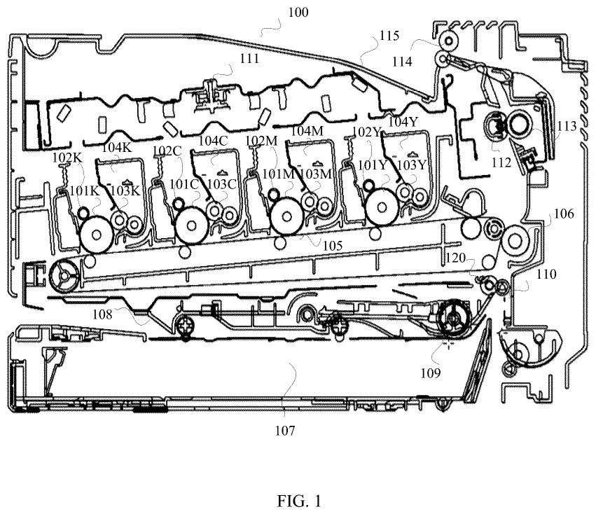

FIG. 1 is a schematic structural diagram of an image forming device according to one embodiment of the present disclosure.

As shown in FIG. 1, an image forming device 100 is used to perform an image forming job such as generating, printing, receiving, and transmitting image data. Examples of the image forming device 100 include a printer, a scanner, a copier, a fax machine, and a multi-functional peripheral (MFP) device that performs the above functions in a single device.

As an example of the image forming device 100, the image forming device 100 includes a photosensitive drum 101Y-K, a charging roller 102Y-K, a developing roller 103Y-K, a toner bin 104Y-K, a transfer belt 105, a secondary transfer roller 106, a paper feed cassette 107, a manual feed tray 108, a paper pickup roller 109, a transport roller 110, a paper detection sensor 120, a laser scanning unit (LSU) 111, a heat roller 112, a pressing roller 113, a discharge roller 114, a discharge paper cassette 115, and so on. Generally, processing cartridges C-M respectively include the photosensitive drum 101Y-K, the charging roller 102Y-K, the developing roller 103Y-K, and the toner bin 104Y-K for holding toner.

LSU 111 is in a form of a single LSU and includes four optical paths. Four charging rollers 102Y-K are used to charge surfaces of four photosensitive drums 101Y-K respectively. The four optical paths of the LSU 111 respectively emit laser beams to form electrostatic latent images on a surface of the photosensitive drum 101Y-K. Four developing rollers 103Y-K are used to respectively develop a toner image of one color on the surface of the photosensitive drum 101Y-K. The image forming device 100 adopts a secondary transfer method, that is, the four photosensitive drums 101Y-K sequentially transfer the toner image to the transfer belt 105, and then the color toner image formed on the transfer belt 105 is secondarily transferred to the paper via the secondary transfer roller 106. The paper feed cassette 107 is used to store papers. The paper pickup roller 109 is used to transport the stored paper to a transport path (i.e., the paper path will be described later). The transport roller 110 transports the paper to the secondary transfer roller 106.

The secondary transfer roller 106 transports an imaged paper to the heat roller 112 and the nip area of the pressing roller 113. The heat roller 112 and the pressing roller 113 are used to fix the toner image on the paper. The heat roller 112 can adopt a ceramic heating method. The heat roller 112 and the pressing roller 113 transport the fixed paper to the discharge roller 114. The discharge roller 114 discharges the paper to the discharge paper cassette 115 and stacks it.

Among them, the LSU 111 acquires an optical analog image signal of the original/source file through exposure of the optical print head. A paper detection sensor 120 is used to detect whether there is paper in the paper path where the paper detection sensor 120 is located.

The paper feed cassette 107 is provided with a paper outlet, and the paper pickup roller 109 is specifically used to send the paper stored in the paper feed cassette 107 from the paper outlet into the paper path for transfer requirements. The image forming device 100 also includes a driving unit (figure not shown) to drive operation of the paper pickup roller 109. The driving unit is a driving motor for driving the operation of the paper pickup roller 109 to realize the paper pickup operation. The driving unit 181 is electrically connected to a controller (figure not shown) of the image forming device, so that the controller can control the operation of the driving unit. The controller is electrically connected to the paper detection sensor 120, and the paper detection sensor sends the detection result information of whether there is paper in the paper path to the controller.

The image forming device 100 further includes an operation panel (figure not shown). The operation panel includes an operation part (figure not shown) composed of various keys and a touch panel display part (figure not shown).

It can be understood that the image forming device 100 listed above is only an example, and a component structure and a component arrangement of the image forming device 100 can be adjusted according to actual conditions without affecting the improvement ideas of the present disclosure.

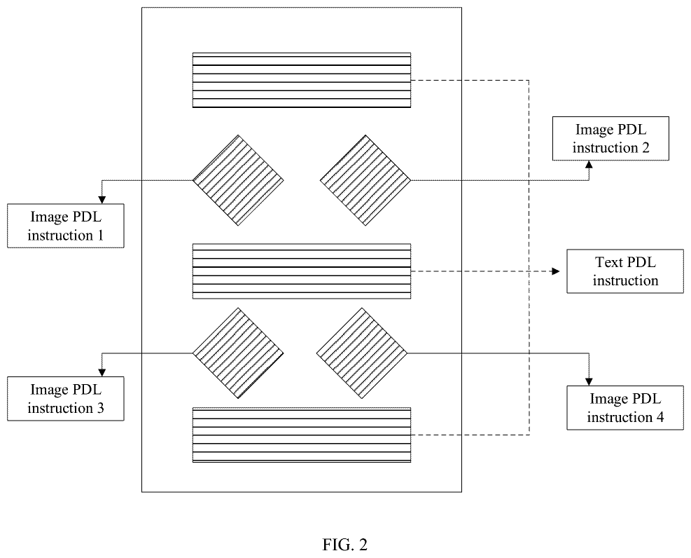

FIG. 2 is schematic diagram of generating a multi-image page description language instruction.

As shown in FIG. 2, if a page to be printed contains text and multiple images, a PDL printer will perform image processing based on the received image-to-be-printed during executing the print job, and convert the image into a page description language readable by the printer. If the image-to-be-printed contains multiple images, a corresponding number of image PDL instructions will be generated based on the multiple images. It takes time to analyze each PDL instruction during printing, which affects the printing speed. The image-to-be-printed described in embodiments of the present disclosure includes multiple images, which refers to graphic images.

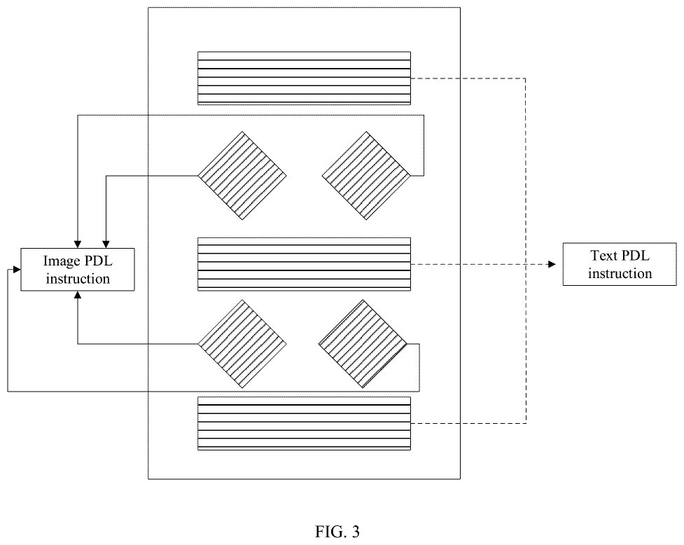

To address the issue, an embodiment of the present disclosure provides an image processing method. As shown in FIG. 3, through the method, when the image-to-be-printed contains multiple images, text of the image-to-be-printed can be converted into a page description language, and the multiple images of the image-to-be-printed can be treated as an entire image and inserted into the page description language through an image instruction, as a target page description language sent to the image forming device to perform an image forming operation. Therefore, the image forming device only needs to restore one image instruction, greatly improving the speed of image restoration and the speed of image generation (such as printing).

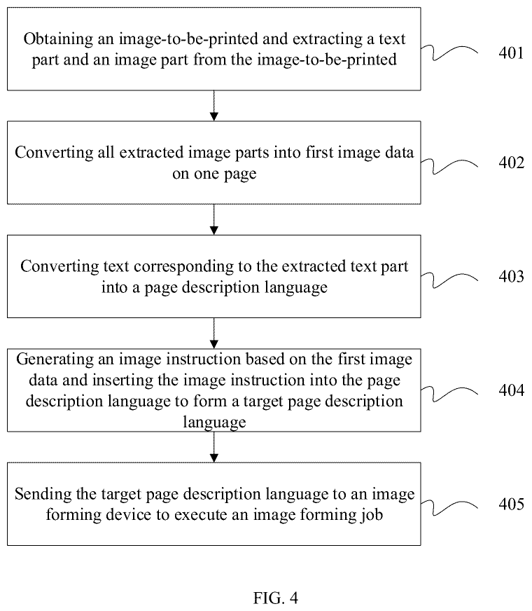

FIG. 4 is a schematic flow chart of an image processing method according to one embodiment of the present disclosure.

Referring to FIG. 4, the method includes several steps.

S401: Obtaining an image-to-be-printed and extract a text part and an image part from the image-to-be-printed.

In some embodiments, prior to extracting the text part and the image part from the image-to-be-printed, it can also detect whether the image-to-be-printed includes an image. If no image is included, text in the image-to-be-printed is directly converted into a page description language and sent to the image forming device (such as a printer) for printing. If an image is included, the text part and the image part are extracted from the image-to-be-printed.

S402: Converting all extracted image parts into first image data on one page.

In some embodiments, prior to S402, the following steps can also be included.

S10: Creating a first page and a second page, where the first page is used to describe the text part of the image-to-be-printed, and the second page is used to describe the image part of the image-to-be-printed.

S403: Converting an extracted text part into a page description language.

In some embodiments, the extracted text part can be converted into a page description language to obtain a rendered first page, and all extracted image parts can also be output using an image instruction of the page description language to obtain the rendered second page.

In some embodiments, the second page has a same size as a printed page size of the image forming device.

In some embodiments, converting all the extracted image parts into first image data on one page can convert all the extracted image parts into pixel level image data on one page (such as the second page). Among them, after the driver-end device extracts the image part of the image-to-be-printed, it renders the corresponding pixels on the second page based on all images. After the rendering is completed, a PDL image instruction is used to place it on the second page based on the area occupied by the image (that is, the position of each pixel point of the image).

In some embodiments, if the driver-end device cannot determine an image occupied area of the image part, all images can be integrated into one image and output to the second page through an image instruction.

In some embodiments, current positions of brushes (cursors) of the first page and the second page are identical. In other words, the first page and the second page can share a cursor. The updates of coordinates are synchronized with each other, that is, the coordinates are updated in a same way as when coordinates are rendered on a page.

S404: Generating one image instruction based on the first image data and inserting the image instruction into the page description language to form a target page description language.

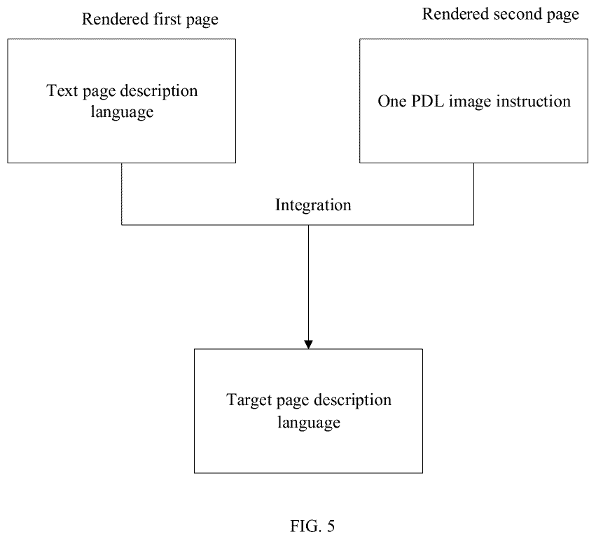

FIG. 5 is a schematic diagram of page integration according to one embodiment of the present disclosure.

Referring to FIG. 5, after acquiring the rendered first page and the second page, the rendered first page and the second page are integrated into a target page. The target page is sent to the image forming device (such as the printer) to execute an image formation job (such as performing a print job).

The rendered first page is a page rendered by converting the text part of the image-to-be-printed into a page description language. The rendered second page is a page rendered by outputting an image-part-to-be-printed through a PDL image instruction. Integrating the rendered first page and second page into the target page can specifically include inserting an image instruction corresponding to the image part into the page description language obtained by converting the text part, thereby obtaining the target page description language.

S405: Sending the target page description language to the image forming device to execute the image forming job.

Among them, when the image-to-be-printed includes multiple images, the target page description language sent to the image forming device also contains only one PDL image instruction. Based on this, when the image forming device performs page restoration after receiving the target page description language, only one image instruction is needed to restore, which greatly improves the speed of restoring the image of image forming device, thereby improving the printing speed of the image forming device, and ensuring the quality of the image.

In some application scenarios, the image part and the text part of the image-to-be-printed can overlap.

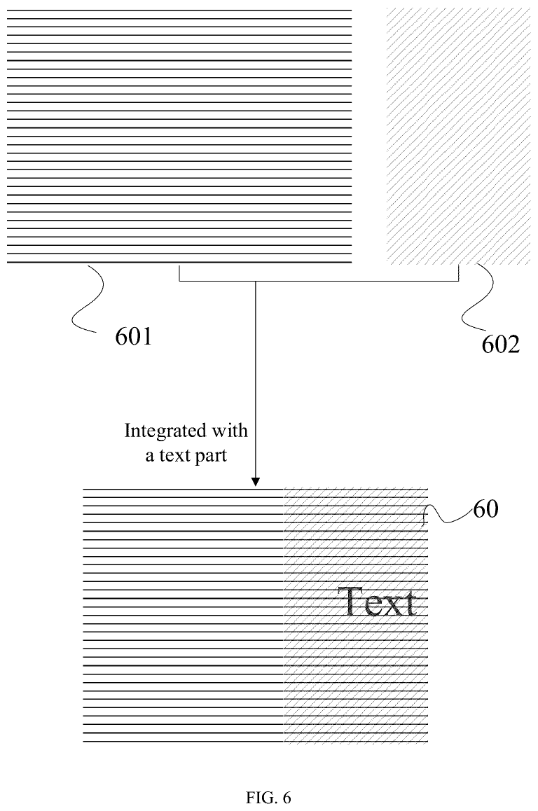

FIG. 6 is a schematic diagram of an overlapping image part and a text part provided by an embodiment of the present application.

Referring to FIG. 6, there is overlap between the image part and the text part in the image-to-be-printed 60. Specifically, the image part includes an image 601 and an image 602. The text part is between the image 601 and the image 602, that is, the image 601 is at the bottom, the text part is in middle, and the image 602 is at the top, and the three overlap. When the image part overlaps with the text part of the image, if the image processing method provided by the embodiment shown in FIG. 4 is adopted, the image may cover the text, thereby affecting the clarity of the text.

In order to address the above technical issues, when the image part and the text part overlap, embodiments of the present disclosure provide another image processing method for image processing.

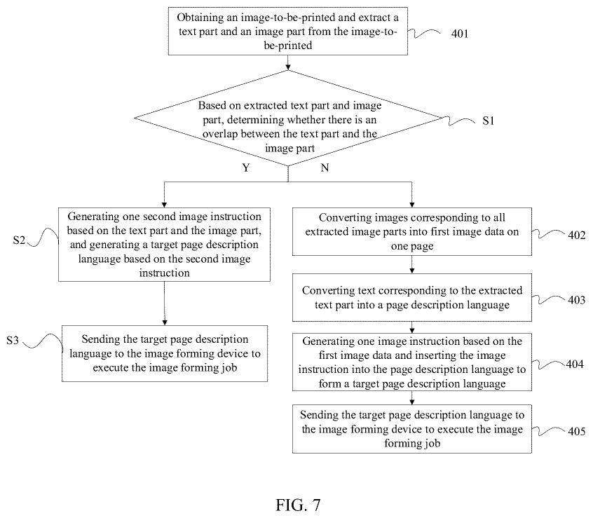

FIG. 7 is a schematic flow chart of an image processing method according to another embodiment of the present disclosure.

Referring to FIG. 7, prior to step S402, the following steps can also be included.

S1: Based on extracted text part and image part, determining whether there is an overlap between the text part and the image part. If there is no overlap, continue to execute S402. If there is an overlap, execute S2.

Specifically, the method of determining whether the text part and the image part overlap can include determining an outline area of the image part, and determining whether the pixel position of the text part overlaps the outline area of the image part.

In some embodiments, the outline area of the image can be determined based on coordinate information of the image. In one embodiment, the outline of the image can be determined simply by obtaining the minimum and maximum coordinates of the image. Specifically, a line segment can be determined based on the obtained minimum coordinate and maximum coordinate, and then a rectangular frame with the line segment as a diagonal can be determined as the outline area of the image. For example, the acquired image part includes two images, namely image A and image B. Further, the minimum coordinate and the maximum coordinate of image A can be obtained. Among them, the minimum coordinate is the intersection point M between the vertical line where the leftmost point of the image is located and the horizontal line where the topmost point of the image is located. The maximum coordinate is the intersection point N between the vertical line where the rightmost point of the image is located and the horizontal line where the bottommost point of the image is located. Point M and point N are connected to obtain a line segment MN. A rectangle is determined based on the line segment MN, and the line segment MN is the diagonal of the rectangle. The obtained rectangle is the outline area of image A. The outline area of image B can be determined based on the same method as described above, which will not be described again.

After obtaining the outline information of the image, it can be further determined whether the pixel position of the text part overlaps with the outline area of the image part. After it is determined that the pixel position of the text part overlaps with the outline area of the image part, it proceeds to executing S2.

S2: Generating a second image instruction based on the text part and the image part, and generating a target page description language based on the second image instruction.

Specifically, when it is determined that the pixel position of the text part overlaps with the outline area of the image part, the corresponding image-to-be-printed can be regarded as an image, thereby a corresponding second image instruction is generated. A target page description language is generated based on the second image instruction.

S3: Sending the target page description language to the image forming device to execute the image forming job.

In some embodiments, if S10 is included prior to S402, S1 can be executed prior to executing S10.

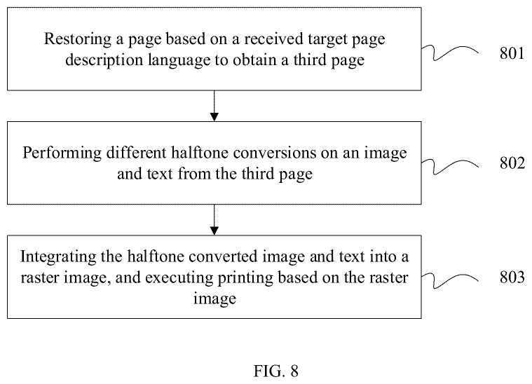

FIG. 8 is a schematic flow chart of an image processing method provided by another embodiment of the present disclosure.

Referring to FIG. 8, the image processing method is executed on an image forming device, and the method can include the following steps.

S801: Restoring the page based on a received target page description language.

S802: Performing different halftone conversions on the image and the text.

S803: Integrating the image and the text being different halftone converted into a raster image, and executing printing based on the raster image.

An image-text separated printed page (the page containing the target page description language) received by the image forming device (such as a printer) contains only one image instruction.

In some embodiments, the driver-end device can direct the image forming device (such as a printer) that the current job is an image-text separation job through a print driver.

After the printer receives a print job in which the image and the text are separated, different data processing methods need to be used because the image needs to be smooth and the text needs to have a clear edge. Therefore, in the process of restoring the page, different halftone conversions can be used for the image and the text. The raster image required by a printing engine can be synthesized and sent to the printing engine for printing.

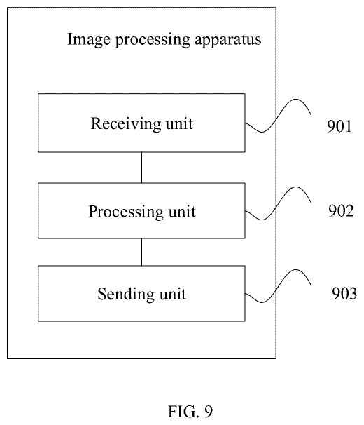

FIG. 9 is a schematic structural diagram of an image processing apparatus according to an embodiment of the present disclosure.

Referring to FIG. 9, the device includes a receiving unit 901, configured to obtain the image-to-be-printed, and extract the text part and the image part from the image-to-be-printed. The device includes a processing unit 902, configured to convert all the extracted image parts into the first image data on one page, convert the extracted text part into page description language, generate an image instruction based on the first image data and insert the image instruction into the page description language, and form a target page description language. The device includes a sending unit 903, configured to send the target page description language to an image forming device to execute an image forming job.

In some embodiments, before converting all the extracted image parts into the first image data on one page, the method further includes: creating a first page and a second page. The first page is used to describe the text part and the second page is used to describe the image part.

In some embodiments, converting all the extracted image parts into the first image data on one page includes: converting all the extracted image parts into pixel-level image data on the second page.

In some embodiments, before converting all the extracted image parts into the first image data on one page, the method further includes: based on the extracted text part and image part, determining whether the text part and the image part overlap. If there is no overlap, then continue to execute the step of converting all the extracted image parts into the first image data on one page. If there is an overlap, then cancel the subsequent steps, generate a second image instruction based on the text part and the image part, and send the page description language including the one second image instruction to the image forming device to execute the image forming job.

In some embodiments, determining whether the text part and the image part overlap includes: determining an outline area of the image part, and determining whether a pixel position of the text part overlaps the outline area of the image part.

In some embodiments, determining the outline area of the image part includes:

determining the minimum coordinate and the maximum coordinate of the image in the image part, and determining a rectangular frame based on the minimum coordinate and the maximum coordinate as the outline area of the image.

In some embodiments, the first page and the second page execute a position update using a same cursor.

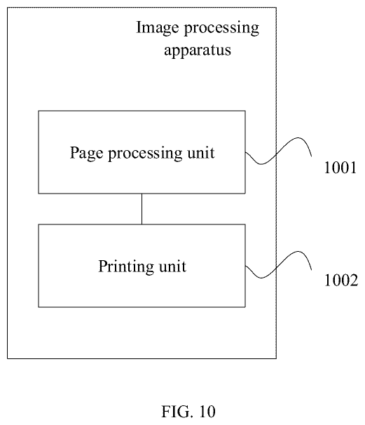

FIG. 10 is a schematic structural diagram of an image processing apparatus provided by another embodiment of the present disclosure.

Referring to FIG. 10, the device can include a page processing unit 1001, configured to restore the page based on the received target page description language, obtain a third page, and execute different halftone conversions on the image and the text in the third page. The device also includes a printing unit 1002, configured to integrate the halftone converted image and text into a raster image, and execute printing based on the raster image.

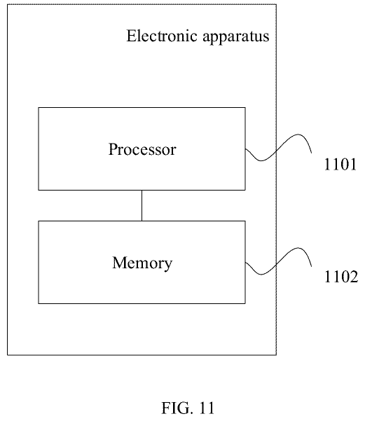

FIG. 11 is a schematic structural diagram of an electronic apparatus provided by an embodiment of the present disclosure.

Referring to FIG. 11, the device may include at least one processor 1101 and a memory 1102. The memory 1102 is used to store at least one instruction. The processor 1101 loads the instruction and executes the image processing method provided by any embodiment of the present disclosure. In some embodiments, the electronic apparatus can be a chip or a chip module.

Embodiments of the present disclosure also provide an image forming device, including an electronic apparatus provided by the embodiment shown in FIG. 11. In some embodiments, the image forming device can implement the image processing method provided by the embodiment shown in FIG. 8.

Embodiments of the present disclosure also provide an image processing system, including a driver-end device and at least one image forming device. Both the driver-end device and the image forming device include the electronic apparatus provided by the embodiment shown in FIG. 11. The driver-end device can at least implement the image processing method provided by the embodiments shown in FIG. 4 or FIG. 7. The image forming device can at least implement the image processing method provided by the embodiment shown in FIG. 8.

Embodiments of the present disclosure also provide a computer-readable storage medium on which a computer program is stored. When the computer program is executed by the processor, the image processing method provided by any embodiment of the present disclosure is implemented.

Embodiments of the present disclosure also provide a computer program product, including a computer program or an instruction. When the computer program or the instruction is executed by the processor, the image processing method provided by any embodiment of the present disclosure is implemented.

It should be noted that a terminal involved in embodiments of the present disclosure includes, but are not limited to, personal computers (PCs), personal digital assistants (PDAs), wireless handheld devices, tablet computers, mobile phones, MP3 players, MP4 players, etc.

It can be understood that an application can be an application program installed in the terminal (nativeApp), or a web page program (webApp) of the browser in the terminal, which is not limited in embodiments of the present disclosure.

Those persons of skilled in the art can clearly understand that for the convenience and simplicity of description, the specific working processes of the system, device, and unit described above can be referred to the corresponding processes in embodiments of the present disclosure, and will not be described again.

In some embodiments, the disclosed system, apparatus, and method can be implemented in other ways. For example, the apparatus embodiment described above are only illustrative. For example, the division of the units is only a logical functional division. In actual implementation, there may be other division methods. For example, multiple units or components may be integrated. Either it can be integrated into another system, or some features can be ignored, or not implemented. On the other hand, the coupling or direct coupling or communication connection between each other shown or discussed may be through some interfaces, and an indirect coupling or communication connection of the apparatuses or units can be in electrical, mechanical, or other forms.

The units described as separate components may or may not be physically separated, and the components shown as units may or may not be physical units, that is, they may be in one place, or they may be distributed to multiple units in network. Some or all units can be selected according to actual needs to achieve the purpose of the solution of embodiments of the present disclosure.

In addition, each functional unit in various embodiments of the present disclosure may be integrated into one processing unit, or each unit may exist physically alone, or two or more units may be integrated into one unit. The above integrated unit can be implemented in the form of hardware or in the form of hardware plus software functional units.

The integrated unit implemented in the form of a software functional unit can be stored in a computer-readable storage medium. The software functional unit is stored in a storage medium and includes instructions to cause a computer device (which can be a personal computer, a server, or a network device, etc.) or a processor to execute some steps of the method described in various embodiments of the present disclosure. The storage medium includes: U disk, mobile hard disk, read-only memory (ROM), random access memory (RAM), magnetic disk, optical disk, or other medium that can store program code.

The above are only preferred embodiments of the present disclosure and are not intended to limit the present disclosure. Any modifications, equivalent substitutions, improvements, etc. made within the spirit and principles of the present disclosure shall be included within the scope of protection.

It should be noted that the above embodiments are only used to illustrate the technical solution of the present disclosure, but not to limit it. Although the present disclosure has been described in detail with reference to the above embodiments, those persons of ordinary skill in the art should understand that the technical solutions described in the above embodiments can still be modified, or some or all the technical features can be equivalently replaced. The modifications or substitutions do not deviate from the essence of the corresponding technical solutions from the scope of the technical solutions of embodiments of the present disclosure.

What is claimed is:

1. An image processing method, applied to a driver-end device, comprising:
obtaining an image-to-be-printed and extracting a text part and an image part from the image-to-be-printed;
converting all extracted image parts on one page into first image data;
converting the extracted text part into a page description language;
generating an image instruction based on the first image data and inserting the image instruction into the page description language to form a target page description language; and
sending the target page description language to an image forming device to execute an image forming job.

2. The image processing method according to claim 1, prior to converting all extracted image parts on one page into first image data, further comprising:
creating a first page and a second page, wherein the first page is configured to describe the text part, and the second page is configured to describe the image part.

3. The image processing method according to claim 2, wherein converting all extracted image parts on one page into first image data comprises:
converting all the extracted image parts into pixel-level image data on the second page.

4. The image processing method according to claim 1, prior to converting all extracted image parts on one page into first image data, comprising:
according to the extracted text part and image part, determining whether there is an overlap between the text part and the image part; when there is no overlap, continuing to execute the step of converting all extracted image parts on one page into first image data; when there is an overlap, cancelling subsequent steps, generating one second image instruction based on the text part and the image part, and sending the page description language that comprises the second image instruction to the image forming device to execute the image forming job.

5. The image processing method according to claim 4, wherein determining whether there is the overlap between the text part and the image part comprises:
determining an outline area of the image part, and determining whether a pixel position of the text part overlaps with the outline area of the image part.

6. The image processing method according to claim 5, wherein determining the outline area of the image part comprises:
determining a minimum coordinate and a maximum coordinate of an image in the image part; and
determining an outline area of the image according to a rectangular frame determined by the minimum coordinate and the maximum coordinate.

7. An image processing method, applied to an image forming device, comprising:
restoring a page based on a received target page description language to obtain a third page;
performing different halftone conversions on an image and text from the third page; and
integrating the halftone converted image and text into a raster image, and executing printing based on the raster image.

8. A non-transitory computer-readable storage medium containing a computer program that, when being executed, causes at least one processor to perform:
obtaining an image-to-be-printed and extracting a text part and an image part from the image-to-be-printed;
converting all extracted image parts on one page into first image data;
converting the extracted text part into a page description language;
generating an image instruction based on the first image data and inserting the image instruction into the page description language to form a target page description language; and sending the target page description language to an image forming device to execute an image forming job.

9. The storage medium according to claim 8, wherein the at least one processor is further configured to perform:
creating a first page and a second page prior to converting all extracted image parts on one page into first image data, wherein the first page is configured to describe the text part, and the second page is configured to describe the image part.

10. The storage medium according to claim 9, wherein the at least one processor is further configured to perform:
converting all the extracted image parts into pixel-level image data on the second page.

11. The storage medium according to claim 8, wherein the at least one processor is further configured to perform:
prior to converting all extracted image parts on one page into first image data and according to the extracted text part and image part, determining whether there is an overlap between the text part and the image part; when there is no overlap, continuing to execute the step of converting all extracted image parts on one page into first image data; when there is an overlap, cancelling subsequent steps, generating one second image instruction based on the text part and the image part, and sending the page description language that comprises the second image instruction to the image forming device to execute the image forming job.

12. The storage medium according to claim 11, wherein the at least one processor is further configured to perform:
determining an outline area of the image part, and
determining whether a pixel position of the text part overlaps with the outline area of the image part.

13. The storage medium according to claim 12, wherein the at least one processor is further configured to perform:
determining a minimum coordinate and a maximum coordinate of an image in the image part; and
determining an outline area of the image according to a rectangular frame determined by the minimum coordinate and the maximum coordinate.

14. The storage medium according to claim 8, wherein the at least one processor is further configured to perform:
sending the target page description language to the image forming device to execute the image forming job by restoring a page based on the target page description language to obtain a third page; performing different halftone conversions on an image and text from the third page; and integrating the halftone converted image and text into a raster image, and executing printing based on the raster image.
